(19) United States
(12) Patent Application Publication
(10) Pub. No.: US 2010/0219182 A1
(43) Pub. Date: Sep. 2, 2010

(54) APPARATUS AND METHOD FOR HEATING MATERIAL BY ADJUSTABLE MODE RF HEATING ANTENNA ARRAY

(75) Inventor: Francis Eugene Parsche, Palm Bay, FL (US)

Correspondence Address: HARRIS CORPORATION;C/O MCANDREWS HELD & MALLOY, 500 WEST MADISON, CHICAGO, IL, 60661, US

(73) Assignee: Harris Corporation, Melbourne, FL (US)

(21) Appl. No.: 12/395,945

(22) Filed: Mar. 2, 2009

(51) Int. Cl. H05B 6/04

(52) U.S. Cl. 219/660

(57) ABSTRACT

An apparatus for heating a material that is susceptible to RF heating by an RF antenna array. The apparatus includes a source of RF power connected to an antenna array having a plurality of loop antenna sections connected to each other by dipole antenna sections wherein the loop antenna sections and dipole antenna sections create a magnetic near field and an electric near field such that the ratio of magnetic field strength to electric field strength is approximately a predetermined value. Material is heated by the apparatus by placing the material in the near fields of the antenna array and creating magnetic near fields and electric near fields that approximate a ratio that is predetermined to efficiently heat the material and connecting the antenna array to an RF power source.

### STATEMENT REGARDING FEDERALLY SPONSORED RESEARCH OR DEVELOPMENT

[Not Applicable]

### CROSS REFERENCE TO RELATED APPLICATIONS

This specification is related to McAndrews, Held & Malloy attorney docket numbers:

| Atty. Dkt. No. | Ser. No. |
|---|---|
| 20476US01 | 12/396,247 |
| 20478US01 | 12/395,995 |
| 20481US01 | 12/396,192 |
| 20483US01 | 12/396,021 |
| 20484US01 | 12/396,284 |
| 20485US01 | 12/396,057 |
| 20486US01 | 12/395,953 |
| 20496US01 | 12/395,918 |

filed on the same date as this specification, each of which is incorporated by reference herein.

### BACKGROUND OF THE INVENTION

The invention concerns heating of materials, and more particularly heating with radio frequency (RF) energy that can be applied to process flows. In particular, this disclosure concerns an advantageous method for RF heating of materials that are susceptible of heating by RF energy by electric dissipation, magnetic dissipation, electrical conductivity and by a combination of two or more of them. In particular, this invention provides a method and apparatus for heating mixtures containing bituminous ore, oil sands, oil shale, tar sands, or heavy oil during processing after extraction from geologic deposits.

Bituminous ore, oil sands, tar sands, and heavy oil are typically found as naturally occurring mixtures of sand or clay and dense and viscous petroleum. Recently, due to depletion of the world's oil reserves, higher oil prices, and increases in demand, efforts have been made to extract and refine these types of petroleum ore as an alternative petroleum source. Because of the high viscosity of bituminous ore, oil sands, oil shale, tar sands, and heavy oil, however, the drilling and refinement methods used in extracting standard crude oil are typically not available. Therefore, bituminous ore, oil sands, oil shale, tar sands, and heavy oil are typically extracted by strip mining, or from a well in which viscosity of the material to be removed is reduced by heating with steam or by combining with solvents so that the material can be pumped from the well.

Material extracted from these deposits is viscous, solid or semisolid and does not flow easily at normal temperatures making transportation and processing difficult and expensive. Such material is typically heated during processing to separate oil sands, oil shale, tar sands, or heavy oil into more viscous bitumen crude oil, and to distill, crack, or refine the bitumen crude oil into usable petroleum products.

Conventional methods of heating bituminous ore, oil sands, tar sands, and heavy oil suffer from many drawbacks. For example, the conventional methods typically add a large amount of water to the materials and require a large amount of energy. Conventional heating methods do not heat material uniformly or rapidly which limits processing of bituminous ore, oil sands, oil shale, tar sands, and heavy oil. For both environmental reasons and efficiency/cost reasons it is advantageous to reduce or eliminate the amount of water used in processing bituminous ore, oil sands, oil shale, tar sands, and heavy oil, and to provide a method of heating that is efficient and environmentally friendly and that is suitable for post-excavation processing of the bitumen, oil sands, oil shale, tar sands, and heavy oil.

RF heating is heating by exposure to RF energy. The nature and suitability of RF heating depends on several factors. RF energy is accepted by most materials but the degree to which a material is susceptible to heating by RF energy varies widely. RF heating of a material depends on the frequency of the RF electromagnetic energy, intensity of the RF energy, proximity to the source of the RF energy, conductivity of the material to be heated, and whether the material to be heated is magnetic or non-magnetic.

RF heating has not replaced conventional methods of heating petroleum ore such as bituminous ore, oil sands, tar sands, and heavy oil. One reason that RF heating has not been more widely applied to heating of hydrocarbon material in petroleum ore is that it does not heat readily when exposed to RF energy. Petroleum ore possesses low dielectric dissipation factors (ε″), low (or zero) magnetic dissipation factors (μ″), and low or zero conductivity.

### SUMMARY OF THE INVENTION

An aspect of the invention concerns an apparatus for heating a material that is susceptible RF heating by an RF antenna array. The apparatus includes a source of RF power connected to an antenna array having a plurality of loop antenna sections connected to each other by dipole antenna sections wherein the loop sections and dipole sections create a magnetic near field and an electric near field such that the ratio of magnetic field strength to electric field strength is approximately a predetermined value.

Another aspect of the invention concerns a method of heating a material by RF heating by determining a ratio of RF electric field strength to RF magnetic strength that will heat the material, providing an antenna array having a plurality of loop antenna sections connected to each other by dipole sections wherein the loop sections and dipole sections create a magnetic near field strength and an electric near field strength that approximate the ratio, connecting the antenna array to an RF power source and placing the material within the magnetic and electric near fields of the antenna array.

### BRIEF DESCRIPTION OF THE DRAWINGS

FIG. 1 illustrates the near field electric and magnetic fields of a dipole antenna.

FIG. 2 illustrates the near field electric and magnetic fields of a loop antenna.

FIG. 3 illustrates an apparatus for heating material by an RF antenna array according to the present invention.

FIG. 4 illustrates an RF antenna array according to the present invention configured to provide strong near field magnetic fields.

FIG. 5 illustrates an RF antenna array according to the present invention configured to provide strong near field electric fields.

FIG. 6 illustrates the antenna array shown by FIG. 3 surrounding a pipe within which flows a material that is susceptible to RF heating by the antenna array.

### DETAILED DESCRIPTION OF THE PREFERRED EMBODIMENTS

The present invention will now be described more fully hereinafter with reference to the accompanying drawings, in which one or more embodiments of the invention are shown. This invention may, however, be embodied in many different forms and should not be construed as limited to the embodiments set forth herein. Rather, these embodiments are examples of the invention, which has the full scope indicated by the language of the claims. Like numbers refer to like elements throughout.

RF heating occurs in the reactive near field region of an antenna. The electric and magnetic fields in this region depend on the antenna from which RF energy is emitted.

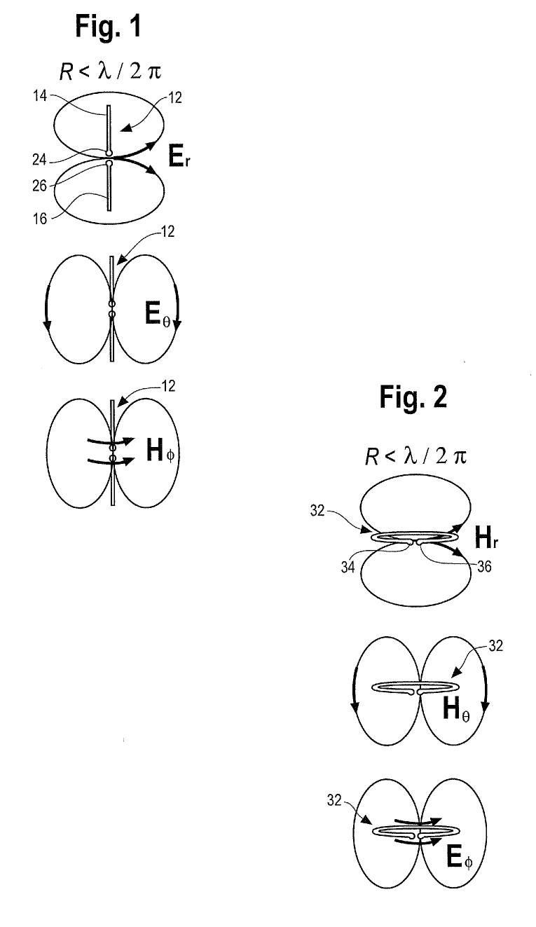

FIG. 1 illustrates the near field region electric (E) and magnetic (H) fields of a dipole antenna 12. The antenna 12 comprises two separate and oppositely extending sections 14 and 16 that are connected to RF energy at connections located at the separation between them, 24 and 26 respectively. The antenna 12 is generally straight and conducts RF energy along its length to create the electric fields, Eᵣ and E_{θ}, and magnetic field H_{φ} in the near field that surrounds the antenna 12. The near field of dipole antenna 12 that provides the most intense heating is the electric field Eᵣ.

FIG. 2 illustrates the near field region electric (E) and magnetic (H) fields of a loop antenna 32. The loop antenna 32 conducts RF current around the antenna 32 between connections 34 and 36. The loop antenna 32 creates the electric field E_{φ} and magnetic fields Hᵣ and H_{θ} in the near field that surrounds the antenna 32. The near field of loop antenna 32 that provides the most intense heating is the magnetic field Hᵣ.

Electric fields heat materials that exhibit dielectric dissipation and magnetic fields heat materials that exhibit magnetic dissipation. Materials that are conductive are heated by eddy currents that can be induced by both magnetic and electric fields. Materials are most efficiently heated by RF energy when the strongest fields created by an antenna are fields that most effectively heat the material. For example, conductive material such as water and particularly water mixed with sodium hydroxide is heated by eddy current created by an RF magnetic field. Material that is not conductive but that exhibits dielectric dissipation is heated by RF electric fields. RF heating of a material is most efficient when the RF fields are those to which the material is most susceptible of heating.

Hydrocarbons from geologic formations are poor conductors and heat little by dielectric and magnetic dissipation. RF heating of a mixture containing such hydrocarbons is accomplished by RF heating of other materials in the mixture which heat the hydrocarbons by thermal conduction. RF heating of such mixtures requires providing RF fields that will efficiently heat materials in the mixture that are susceptible to RF heating. Those materials can include material with which hydrocarbons are mixed in the subsurface formation and material that may be added during processing. Copending applications by the inventor having docket numbers 20478US01 and 20483US01 disclose heating of hydrocarbons by mixing hydrocarbons with materials that are strongly susceptible to heating by RF energy and that then heat hydrocarbons in the mixture by thermal conduction.

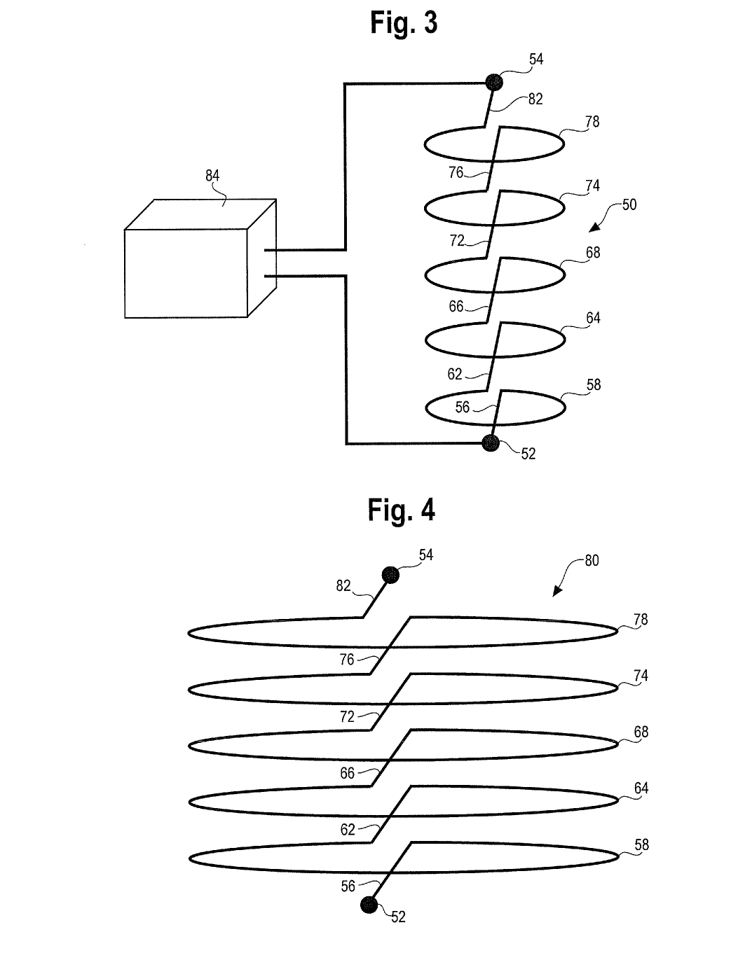

FIG. 3 illustrates an antenna array 50 according to the present invention for RF heating of material that is heated by both magnetic and electric fields. The antenna array 50 extends from connection 52 to connection 54 at which it is connected to an RF energy source 84. The antenna array 50 consists of a series of loop sections 58, 64, 68, 74 and 78 that are connected sequentially to each other by dipole sections 62, 66, 72 and 76. A dipole section 56 connects the connection 52 to the loop 58 and a dipole section 82 connects he loop 78 to the connection 54. The antenna array 50 is connected at connections 52 and 54 to the RF power source 84. The antenna array 50 creates a series of alternating dipole antenna fields and loop antenna fields.

The predominance and strength of the magnetic and electric fields created by the antenna 50 are determined by the dimensions of the dipole sections 56, 62, 66, 72, 76 and 82 and by the number and dimensions of the loop sections 58,64, 68, 74 and 78. Magnetic field strength of the antenna is increased by increasing the diameter and number of loop sections. Magnetic field strength of the antenna is decreased by providing fewer loop sections and smaller diameter loop sections. Electric field strength is increased by providing longer dipole sections. The ratios of magnetic and electric near field strengths for an antenna array according to the present invention can therefore be determined by configuring the antenna with the needed number and sized loop sections connected by dipole sections.

FIG. 4 illustrates an antenna 80 according to the present invention for RF heating of material that is heated by both magnetic and electric fields. The antenna 80 extends from connection 52 to connection 54 and consists of a series of loop sections 58,64, 68, 74 and 78 that are connected sequentially to each other by dipole sections 62, 66, 72 and 76. The antenna 80 has the same number of dipole sections and loop sections as antenna 50, but differs from antenna 50 by having shorter dipole sections and larger diameter loops. As compared to antenna 50, the antenna 80 creates larger and higher energy magnetic fields. The antenna 80 would be preferable to the antenna 50 for heating material that is susceptible to heating by magnetic or conductive heating.

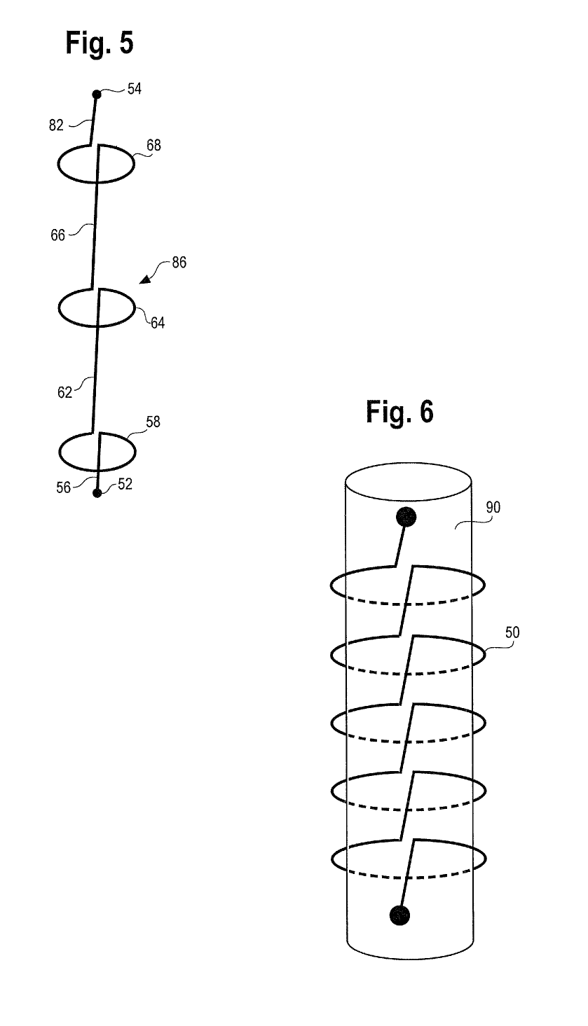

FIG. 5 illustrates an antenna 86 according to the present invention for RF heating of material that is heated by both magnetic and electric fields. The antenna 86 extends from connection 52 to connection 54 and consists of a series of loop sections 58,64, and 68 that are connected sequentially to each other by dipole sections 62 and 66. The antenna 86 has the fewer and longer dipole sections and fewer and smaller loop sections than antenna 50. As compared to antenna 50, the antenna 86 creates smaller and lower energy magnetic fields and a near field in which electric fields predominate. The antenna 86 would be preferable to the antenna 50 for heating material that is susceptible to dielectric heating.

FIG. 6 illustrates the antenna array 50 surrounding a pipe 90. A flowable material (not shown) that is susceptible to RF heating passes through the pipe and within the near field electric and magnetic fields created by the antenna array 50. In accordance with the present invention, the antenna array 50 is sized and configured, by the size and number of loop sections and the lengths of the dipole sections, so that connecting the antenna array 50 to an RF power source will produce near field electric and magnetic fields of the antenna array 50 that will heat the material flowing within the pipe 90.

We claim:

1. An apparatus for heating by an RF antenna array a material that is susceptible RF heating comprising:
a source of RF power
an antenna array connected to the source of RF power, the antenna array having a plurality of loop antenna sections connected to each other by dipole sections wherein the loop sections and dipole sections create magnetic near fields and an electric near fields such that the ratio of magnetic field strength to electric field strength is approximately a predetermined value.

2. A method of heating by RF energy a material that is susceptible to heating by RF energy comprising
determining a ratio of RF electric field strength to RF magnetic strength that will heat the material;
providing an antenna array having a plurality of loop antenna sections connected to each other by dipole antenna sections wherein the loop antenna sections and dipole antenna sections create a magnetic near field strength and an electric near field strength that approximate the ratio;
connecting the antenna array to an RF power source; and
placing the material within the magnetic and electric near fields of the antenna array.
